(19) United States
(12) Patent Application Publication
(10) Pub. No.: US 2005/0106360 A1
(43) Pub. Date: May 19, 2005

(54) Microstructured surface building assemblies for fluid disposition

(76) Inventors: Raymond P. Johnston, Lake Elmo, MN (US); Stephanie B. Castiglione, Hudson, WI (US); Gregory A. Shipp, St. Paul, MN (US); David F. Slama, Grant, MN (US)

Correspondence Address: 3M INNOVATIVE PROPERTIES COMPANY, PO BOX 33427, ST. PAUL, MN, 55133-3427, US

(21) Appl. No.: 10/712,529

(22) Filed: Nov. 13, 2003

(51) Int. Cl. B32B 3/28

(52) U.S. Cl. 428/167

(57) ABSTRACT

The present invention provides for a fluid control assembly comprising a fluid control film comprising a first side and a second side, the first side comprising a microstructured surface with a plurality of channels on the first side; and an exterior building wall assembly comprising a substrate layer having a major surface, the substrate major surface associated with the fluid control film.

### FIELD

The present application is directed to building assemblies with fluid management.

### BACKGROUND

It is widely recognized that trapped water in walls and exterior structures, causes the growth of mold, mildew, and microbes that break down wood, wood products, and many building materials. In this so-called ‘sick home syndrome’, trapped water in walls has been shown to lead to rot and mold in the wall itself, leading to structural and dwelling habitability deterioration. This damage results in expensive repairs, and in extreme cases total loss can result.

Numerous solutions offered to help solve these problems, but they have all suffered from significant disadvantages. Many building solutions seek to improve the water hold out by sealing around windows with caulking, combined with water impervious or resistive layers. New building standards require high-energy efficiency, which leads to low air infiltration. Even air exchange devices that seek to improve indoor air quality do little to remedy water wall infiltration. As improved sealing means have been used, it has now been learned that particularly around windows and doors, water damage has been severe. This problem appears to have been potentially made worse by the extensive sealing caulks and conventional tapes, since once water makes it past the sealing materials it is persistent in the walls. Due to the extensive sealing, the water is unable to leave the interior wall structure.

Alternate methods that have been employed to try and address the damage due to water ingress have included membrane barriers that allow water vapor through them, but resist water penetration. This approach has been used for many years, but is limited to the moisture transport of all the wall layers. Interior wall sections frequently contain poly film layers that resist moisture vapor transport, and many exterior sheathing and sidings are also very poor membranes. As a result, adding a layer of moisture permeable membranes is very limited. Again once liquid invades the wall, it still is retained in the wall section.

Another general approach to build large spaces in the wall to allow ventilation means between the siding and adjacent wall layers. This method does provide a useful means of venting out water vapor, as well as liquid water, however this method is expensive and adds appreciable labor to the construction. Also, the use of wood strips or other spacing materials tends to leave significant spans of siding between the spacing layers. These spans can lead to uneven siding sections due to extensive temperature and humidity swings.

Yet another approach is to use embossed membranes and nonwovens. These materials provide creped channels or embossed projections that leave open spaces for drainage and evaporation. However these materials by their nature are limited. These materials are incapable of providing good sealing due their open and undulating properties, and furthermore these materials are limited in their ability to support compressive loads. The nature of these materials is that of a thin breathable material, that is then expanded in the Z-axis to provide passages. The compressive strength of this type of material is lacking as the thinness of the membrane leads to poor beam strength.

Another approach is the use of flashing tapes. These tapes are wrapped around window and door openings to try and hermetically seal these wall sections. These tapes provide a convenient method of applying a water barrier, but fail to provide a sealing means between the window or door, and adjacent siding. Further, when water does penetrate into this area, these tapes fail to offer a solution to remove the fluid from these openings.

There continues to be a need for a wall section that can effectively seal window and door sections, as well as provide superior wall wrap capabilities, at a cost and ease that manufactures, contractors, and end customers can afford. Further, there is a need for a robust method that can be used at a construction site without greatly altering proven building methods. Exterior structure, like housing, commercial construction, and exterior enclosures that need to shed water would benefit from a material and construction that provides a means of sealing water out, and at the same time provides a fail safe means for removing any liquid that penetrates into the wall section through drainage and/or evaporation.

### SUMMARY

The present invention provides for a fluid control assembly comprising a fluid control film comprising a first side and a second side, the first side comprising a microstructured surface with a plurality of channels on the first side; and an exterior building wall assembly comprising a substrate layer having a major surface, the substrate major surface associated with the fluid control film. The substrate major surface may be associated with the first side of the fluid control film or the second side of the fluid control film.

In certain embodiments, the substrate is a frame for a defined opening, for example a window jamb or a door jamb. The substrate may also be a window sill, wall sheathing, a window, a roof, exterior cladding, or, an exterior protrusion.

### BRIEF DESCRIPTION OF THE DRAWINGS

FIGS. 1a and 1b are schematic diagrams used to illustrate interaction of a fluid on a surface.

FIGS. 2a through 2k are cross-sectional cutaway views of illustrative embodiments of fluid control films of the present invention.

FIG. 3a is a schematic illustration of a channeled microstructured surface of the present invention with a quantity of fluid thereon.

FIG. 3b is a schematic sectional view as taken along line 3b-3b in FIG. 3a.

FIG. 4a is a cross-sectional view of an embodiment of the fluid control film in a roofing structure.

FIG. 4b is a cross-sectional view of an embodiment of the fluid control film in a roofing structure.

FIG. 4c is an elevated view of an embodiment of the fluid control film in a roofing structure.

FIG. 5 is a cross-sectional view of an embodiment of a wall structure with the fluid control film on an exterior wall of an insulated building.

FIG. 6 is an elevated view of an embodiment of the fluid control films in a window opening assembly.

FIG. 7 is an elevated view of an embodiment of the fluid control film on a surface around a window opening assembly.

FIG. 8 is an elevated view of an embodiment of the fluid control film in a window unit assembly.

FIG. 9a is a cross-sectional view of an embodiment of the fluid control films in a external protrusion of a wall assembly.

FIG. 9b is a blow-up of a portion of the fluid control film of FIG. 9a.

### DETAILED DESCRIPTION

The present application is directed to a fluid control film. Suitable fluid control films include those fluid control films described in U.S. Pat. No. 6,531,206, to Johnston et al., incorporated in its entirety by reference.

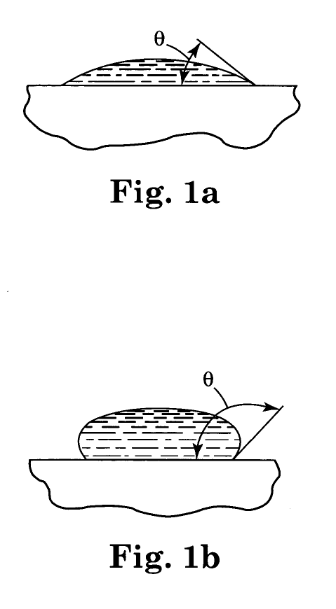

The fluid control film comprises a microstructured surface. As shown in FIGS. 1a and 1b, the contact angle Theta is the angle between a line tangent to the surface of a bead of fluid on a surface at its point of contact to the surface and the plane of the surface. A bead of fluid whose tangent was perpendicular to the plane of the surface would have a contact angle of 90°. Typically, if the contact angle is 90° or less, as shown in FIG. 1a, the solid surface is considered to be wet by the fluid. Surfaces on which drops of water or aqueous solutions exhibit a contact angle of less than 90° are commonly referred to as “hydrophilic”. As used herein, “hydrophilic” is used only to refer to the surface characteristics of a material, i.e., that it is wet by aqueous solutions, and does not express whether or not the material absorbs aqueous solutions. Accordingly, a material may be referred to as hydrophilic whether or not a sheet of the material is impermeable or permeable to aqueous solutions. Thus, hydrophilic films used in the present application may be formed from films prepared from resin materials that are inherently hydrophilic, such as for example, poly(vinyl alcohol). Fluids which yield a contact angle of near zero on a surface are considered to completely wet out the surface. Polyolefins, however, are typically inherently hydrophobic, and the contact angle of a polyolefin film, such as polyethylene or polypropylene, with water is typically greater than 90°, such as shown in FIG. 1b.

The fluid control films of the invention may have a variety of topographies. Exemplary fluid control films are comprised of a plurality of channels with V-shaped or rectangular cross-sections, and combinations of these, as well as structures that have channels, secondary channels, i.e., channels within channels. Additionally, the topography may include microstructured posts and protrusions.

The channels on the microstructured surface have channel ends. In certain embodiments, the fluid control film may include a removing means. The removing means generally withdraws fluid from the channels adjacent one of the channel ends. In another embodiment, the removing means withdraws the fluid from the channels adjacent both channel ends. The removing means may include an absorbent material disposed in communication with the channels. In one embodiment, the removing means includes a fluid drip collector.

Generally, the channels in the microstructure are defined by generally parallel ridges including a first set of ridges having a first height and a second set of ridges having a second, taller height. An upper portion of each ridge of the second set of ridges may have a lower melting temperature than a lower portion thereof. The channels have a pattern geometry selected from the group consisting of linear, curvilinear, radial, parallel, nonparallel, random, or intersecting.

One embodiment includes forming at least one cross-channel on the polymeric microstructured surface to join at least two adjacent channels of the plurality of channels for fluid flow there between.

In alternate embodiments, the projections are ridges and/or may be discontinuous along the channels. The microstructured surface may further include defining additional surface texture features on the polymeric microstructured surface in order to increase the surface area thereon for removing the fluid. In one embodiment, the polymeric microstructured surface has generally parallel channels extending between first and second ends thereof.

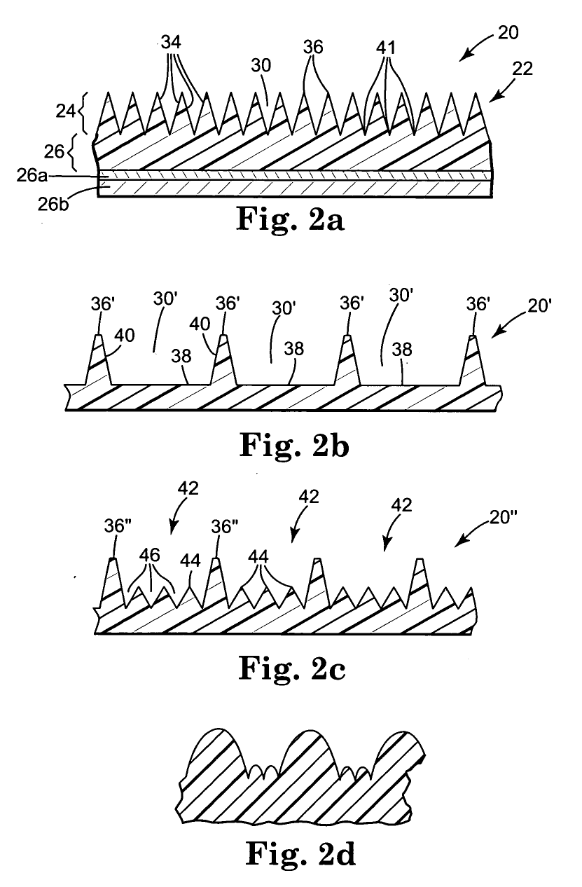

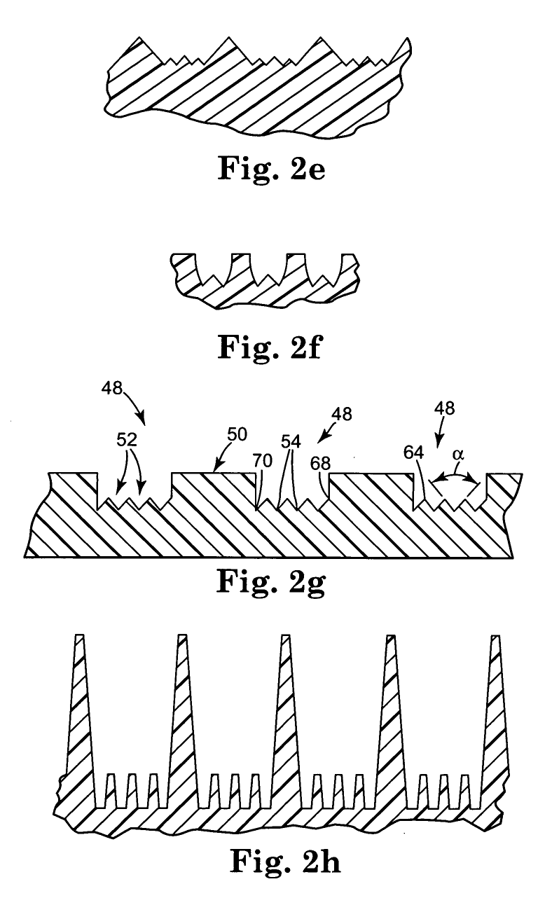

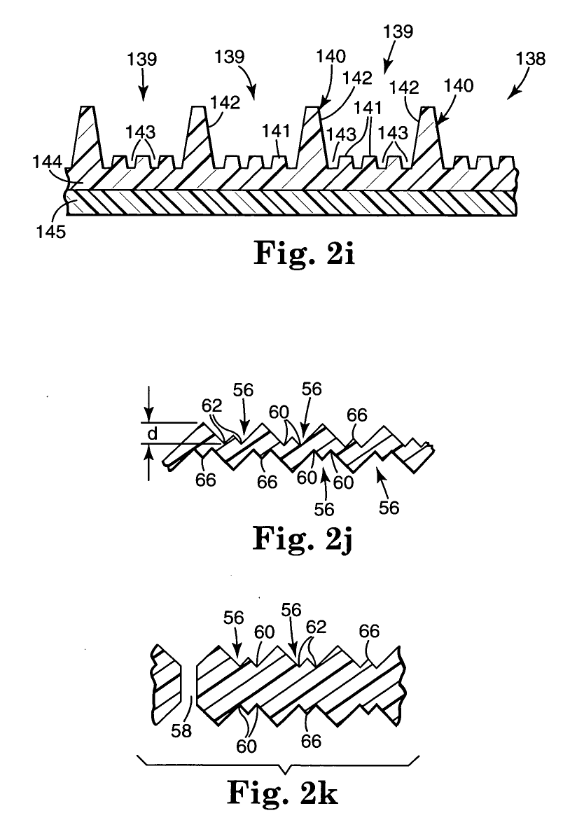

The channels of fluid control films of the present invention can be of any geometry that provides desired fluid transport, and generally one that is readily replicated. For spontaneous wicking or transport along open channels, the desired contact angle of the microstructured surface/fluid interface of V-channeled fluid control films is such that:
Theta≦(90°−Alpha/2),
wherein Theta is the contact angle of the fluid with the film and Alpha (α) is the average included angle of the secondary V-channel notches. (See, e.g., FIG. 2g).

The channels of fluid control films of the present invention can be of any geometry that provides desired fluid transport. In some embodiments, the fluid control film will have primary channels on only one major surface as shown in FIGS. 2a-2i. In other embodiments, however, the fluid control film will have primary channels on both major surfaces, as shown in FIGS. 2j and 2k.

As shown in FIG. 2a, a fluid control film 20 of the present invention includes a layer 22 of polymeric material that has a structured surface 24 on one of its two major surfaces. The layer 22 includes a body layer 26 from which the structured surface 24 projects. The body layer 26 serves to support the structured surface 24 in order to retain the individual structured features together in layer 22.

As shown in FIG. 2a, channels 30 can be defined within the layer 22 in accordance with the illustrated embodiment by a series of v-shaped sidewalls 34 and peaks 36. Each peak or projection may define a continuous ridge running along each channel, or the peaks may be formed as discontinuous elements (e.g., pins, bars, etc.) which still functionally serve to define the channels therebetween. In some cases, the sidewalls 34 and peaks 36 may extend entirely from one edge of the layer 22 to another without alteration—although, in some applications, it may be desirable to shorten the sidewalls 34 and thus extend the peaks 36 only along a portion of the structured surface 24. That is, channels 30 that are defined between peaks 36 may extend entirely from one edge to another edge of the layer 22, or such channels 30 may only be defined to extend over a portion of the layer 22. Channels 30 that extend only over a portion may begin at an edge of the layer 22, or they may begin and end intermediately within the structured surface 24 of the layer 22. The channels 30 are defined in a predetermined arrangement over a continuous surface of polymeric material. The arrangement may be ordered or random.

Other channel configurations are contemplated. For example, as shown in FIG. 2b, a fluid control film 20′ has channels 30′ which have a wider flat valley between slightly flattened peaks 36′. Like the FIG. 2a embodiment, a cap layer (not shown) can be secured along one or more of the peaks 36′ to define discrete channels 30′. In this case, bottom surfaces 38 extend between channel sidewalls 40, whereas in the FIG. 2a embodiment, sidewalls 34 connect together along lines 41.

FIG. 2c illustrates an alternate fluid control film 20″ where wide channels 42 are defined between peaks 36″, but instead of providing a flat surface between channel sidewalls 40, a plurality of smaller peaks 44 are located between the sidewalls 40′ of the peaks 36″. These smaller peaks 44 thus define secondary channels 46 therebetween. Peaks 44 may or may not rise to the same level as peaks 36″, and as illustrated create a first wide channel 42 including smaller channels 46 distributed therein. The peaks 36″ and 44 need not be evenly distributed with respect to themselves or each other.

FIGS. 2d-2k illustrate various alternative embodiments of the fluid control film of the present invention. Although FIGS. 2a-2k illustrate elongated, linearly-configured channels, the channels may be provided in other configurations. For example, the channels could have varying cross-sectional widths along the channel length—that is, the channels could diverge and/or converge along the length of the channel. The channel sidewalls could also be contoured rather than being straight in the direction of extension of the channel, or in the channel height. Generally, any channel configuration that can provide at least multiple discrete channel portions that extend from a first point to a second point within the fluid transport device are contemplated. The channels may be configured to remain discrete along their whole length if desired.

With reference to FIG. 2g, one geometry is a rectilinear primary channel 48 in a flat film 50. The primary channel 48 has included secondary channels 52 which forms a multitude of notches 54. The notches 54 (or secondary channels 52, where the secondary channels 52 are V-shaped and have substantially straight sidewalls) have a notch included angle of (i.e., angle Alpha) from about 10° to about 120°, for example from about 10° to about 100°, and in some embodiments from about 20° to about 95°. The notch included angle is generally the secant angle taken from the notch to a point 2 to 1000 microns from the notch on the sidewalls forming the notch, for example the notch included angle is the secant angle taken at a point halfway up the secondary channel sidewalls. It has been observed that notches with narrower included angular widths generally provide greater vertical wicking distance. However, if Alpha is too narrow, the flow rate will become significantly lower. If Alpha is too wide, the notch or secondary channel may fail to provide desired wicking action. As Alpha gets narrower, the contact angle of the fluid need not be as low, to get similar fluid transport, as the contact angle must be for notches or channels with higher angular widths.

Generally, the primary channel maximum width is less than 3000 microns, for example less than 1500 microns. The included angle of a V-channel shaped primary channel will generally be from about 10 degrees to 120 degrees, for example 30 to 110 degrees. If the included angle of the primary V-channel is too narrow, the primary channel may not have sufficient width at its base so that it is capable of accommodating an adequate number of secondary channels. Generally, the included angle of the primary channel be greater than the included angle of the secondary channels so as to accommodate the two or more secondary channels at the base of the primary channel. Generally, the secondary channels have an included angle at least 20 percent smaller than the included angle of the primary channel (for V-shaped primary channels).

With reference to FIGS. 2g and 2j, the depth of the primary channels (48, 56) (the height of the peaks or tops above the lowermost channel notch), “d”, is substantially uniform. The height “d” may range from about 5 to about 3000 microns, for example from about 25 to about 1500 microns, and in some embodiments from about 50 to about 1000 microns, for example from about 50 to about 350 microns. It will be understood that in some embodiments films with channels (48, 56) having depths larger than the indicated ranges may be used. If the channels are unduly deep, the overall thickness of the fluid control film will be unnecessarily high and the film may tend to be stiffer than is desired. The width of the primary channel at its base may be sufficient to accommodate two or more secondary channels.

FIGS. 2j and 2k illustrate fluid control films having primary channels on both major surfaces. As shown in FIG. 2j, the primary channels 56 may be laterally offset from one surface to the other surface or may be aligned directly opposite each other as shown in FIG. 2k. A fluid control film with offset channels as shown in FIG. 2j provides a maximum amount of surface area for wicking while at the same time using a minimum amount of material. In addition, a fluid control film with offset channels can be made so as to feel softer, due to the reduced thickness and boardiness of the sheet, than a fluid control film with aligned channels as shown in FIG. 2k. As shown in FIG. 2k, fluid control film of the invention may have one or more holes or apertures 58 therein, which enable a portion of the fluid in contact with the front surface of the fluid control film to be transported to the back surface of the film, to improve fluid control. The apertures need not be aligned with the notch of a channel and do not need to be of about equal width as the channels. The surfaces of the fluid control film within the apertures may be hydrophilic.

As illustrated in FIGS. 2g and 2j, in each primary channel (48, 56) are at least two secondary channels (52, 60) and at least two notches (54, 62), the notch or notches of each secondary channel (52, 60) is separated by a secondary peak (64, 66). Generally, each secondary channel will generally have only one notch, but a secondary channel will have two notches if the secondary channel is rectangular. The secondary peak (64, 66) for V-channel shaped secondary channels is generally characterized by an included angle β which is generally equal to (α¹+α²)/2 where α¹ and α² are the included angles of the two adjacent V-channel shaped secondary channels (52, 60), assuming that the two sidewalls forming each secondary channel are symmetrical and not curved. Generally, the angle β would be from about 10° to about 120°, for example from about 10° to about 110°, and in some embodiments from about 20° to about 100°. The secondary peak could also be flat (in which case the included angle would theoretically be 0°) or even curved, e.g., convex or concave, with no distinct top or included angle. Generally, there are at least three secondary channels (52, 60) and/or at least three notches for each primary channel (48, 56), (including any notches (54, 62) associated with the end channels such as notches 68 or 70 as shown in FIG. 2g).

The depth of one of the secondary channels (52, 60) (the height of the top of the secondary peaks 64 over the notches 54) is uniform over the length of the fluid control films, and is typically at least 5 microns. The depth of the secondary channels (52, 60) is generally 0.5 to 80 percent of the depth of the primary channels, for example 5 to 50 percent. The spacing of the notches (54, 62) on either side of a peak may be uniform over the length of the fluid control film. The primary and/or secondary channel depth and width may vary by less than 20 percent, for example less than 10 percent for each channel over a given length of the fluid control film. Variation in the secondary channel depth and shape above this range has a substantial adverse impact on the rate and uniformity of fluid transport along the fluid control film. Generally the primary and secondary channels are continuous and undisturbed.

The individual flow channels of the microstructured surfaces of the invention may be substantially discrete. That is, fluid can move through the channels independent of fluid in adjacent channels. The channels independently accommodate the potential relative to one another to direct a fluid along or through a particular channel independent of adjacent channels. Generally, fluid that enters one flow channel does not, to any significant degree, enter an adjacent channel, although there may be some diffusion between adjacent channels. It is important to effectively maintain the discreteness of the channels in order to effectively transport the fluid and maintain advantages that such channels provide. Not all of the channels, however, may need to be discrete for all embodiments. Some channels may be discrete while others are not.

Certain microstructured surfaces have a channels. Such channels have a minimum aspect ratio (defined for channels as length/hydraulic radius) of 10:1, in some embodiments exceeding approximately 100:1, and in other embodiments at least about 1000:1. At the top end, the aspect ratio could be indefinitely high but generally would be less than about 1,000,000:1. The hydraulic radius of a channel is no greater than about 300 micrometers. In many embodiments, it can be less than 100 micrometers, and may be less than 10 micrometers. Although smaller is generally better for many applications (and the hydraulic radius could be submicron in size), the hydraulic radius typically would not be less than 1 micrometers for most embodiments. As more fully described below, channels defined within these parameters can provide efficient bulk fluid transport through an active fluid transport device.

The structured surface can also be provided with a very low profile. Thus, fluid transport devices are contemplated where the structured polymeric layer has a thickness of less than 5000 micrometers, for example less than about 3500 micrometers. In some embodiments, the thickness is less than about 1500 micrometers, for example less than 700 micrometers, and in specific embodiments less than 650 micrometers. To do this, the microstructured features may be defined by peaks that have a height of greater than about 5 micrometers, for example greater than 50 micrometers, and in some embodiments greater than about 100 micrometers. The peaks generally have a height less than 1200 micrometers, for example less than 1000 micrometers, and in some embodiments less than 700 micrometers. The microstructured features may be defined by peaks that have a distance between peaks of greater than about 10 micrometers, for example greater than 100 micrometers, and in some embodiments greater than about 200 micrometers. The elements generally have a distance less than 4500 micrometers, for example less than 2000 micrometers, and in some embodiments less than 1500 micrometers.

Some embodiments of fluid channels for use in the present invention may be of any suitable geometry but are generally rectangular (typically having depths of 50 to 3000 micron and widths of 50 to 3000 micron or “V” channel patterns (typically having depths of about 50 to 3000, for example 500 micrometers, and heights of 50 to 3000, for example 500 micrometers) with an included angle of generally 20 to 120 degrees, for example about 45 degrees.

One embodiment of a fluid transport film of the present invention is illustrated in FIG. 2i as alternate fluid control film 138. The film 138 has wide channels 139 defined between peaks 140. A plurality of smaller peaks 141 are located between side walls 142 of the peaks 140. The smaller peaks 141 thus define secondary channels 143 therebetween. The smaller peaks 141 are not as high as the peaks 140 and, as illustrated, create a first wide channel 139 including smaller channels 143 distributed therein.

Suitable fluid control films of the present invention may be made, for example, through a process such as extrusion, injection molding, embossing, hot stamping, etc. In embossing, a substrate (e.g., a thermoplastic material) is deformed or molded. This process is usually performed at an elevated temperature and perhaps under pressure. The substrate or material may be made to replicate or approximately replicate the surface structure of a master tool. Since this process produces relatively small structures and is sometimes repeated many times over the process is referred to as microreplication. Suitable processes for microreplication are described in U.S. Pat. No. 5,514,120.

Referring again to FIG. 2a for illustrative purposes, the layer 22 includes the structured surface 24 and the underlying body layer 26. The layer 22 may include one or more additional layers of material (such as layers 26a or 26b) on its side opposite the structured surface 24, or such additional layers or other materials may be embedded within the body layer 26. The body layer 26 (and possible additional layers or materials therein) constitute backings for the structured surface 24. Suitable backings for use in fluid control articles of the present invention include conventional backings known in the art including non-woven and woven fibrous webs, knits, films, foams, micro and nono-porous materials and other familiar backing materials. Some backings include thin (e.g., less than about 1.25 mm, for example less than about 0.05 mm) and elastomeric backings. These types of backings help ensure conformability and high adhesion of the inventive fluid transport layer to and over substrate surface irregularities. Backing materials include, for example, polyurethanes, polyether polyesters, polyether amides as well as polyolefins (e.g. low density polyethylene), cellulosic materials. Another useful backing would also incorporate a flame retardant material. A multilayer approach could be used to provide a microreplicated film by coextrusion of multiple layers, one or more being flame retardant (such as disclosed in Kollaja et al., PCT International Publication No. WO 99/28128) and maintaining surface hydrophilicity.

Suitable adhesives for use in fluid transport articles of the present invention include any adhesive that provides acceptable adhesion to a variety or polar and non-polar substrates. Adhesives may be pressure sensitive and in certain embodiments may repel absorption of aqueous materials and do not contribute to corrosion. Suitable pressure sensitive adhesives include those based on acrylates, polyurethanes, block copolymers, silicones, rubber based adhesives (including natural rubber, polyisoprene, polyisobutylene, butyl rubber etc.) as well as combinations of these adhesives. The adhesive component may contain tackifiers, plasticizers, rheology modifiers as well as active components such as an antimicrobial agent for the retardation of mold and mildew in the building assembly. Removable liners may be used to protect the adhesive surface prior to use.

Exemplary pressure sensitive adhesives which can be used in the adhesive composites of the present invention are the normal adhesives which are applied to various substrates, such as the acrylate copolymers described in U.S. Pat. No. RE 24,906, and particularly a 97:3 isooctyl acrylate:acrylamide copolymer. Another example is an 65:35 2-ethylhexyl acrylate:isobornyl acrylate copolymer, and useful adhesives for this purpose are described in U.S. Pat. Nos. 5,804,610 and 5,932,298. Another useful adhesive could be a flame retardant adhesive. The inclusion of antimicrobial agents in the adhesive is also contemplated, as described in U.S. Pat. Nos. 4,310,509 and 4,323,557.

The structured surface may also be incorporated into an adhesive layer. In this case the adhesive must either be supported by a microreplicated liner having the mirror image of the fluid wick pattern or the adhesive must have sufficient yield stress and/or creep resistance to prevent flow and loss of the pattern during storage. Increase in yield stress is most conveniently accomplished by slightly crosslinking the adhesive (e.g., using covalent and/or ionic crosslinks or by providing sufficient hydrogen bonding). It is also understood that the adhesive layer may be discontinuous via the same methods, to allow for easy, bubble free application. Liners which are suitable for use in the adhesive composites of the present invention can be made of kraft papers, polyethylene, polypropylene, polyester or composites of any of these materials.

The liners are generally coated with release agents such as fluorochemicals or silicones. For example, U.S. Pat. No. 4,472,480 describes low surface energy perfluorochemical liners. Examples of liners are papers, polyolefin films, or polyester films coated with silicone release materials. Examples of commercially available silicone coated release papers are POLYSLIK™ silicone release papers available from James River Co., H.P. Smith Division (Bedford Park, Ill.) and silicone release papers supplied by Daubert Chemical Co. (Dixon, Ill.). A specific liner is 1-60BKG-157 paper liner available from Daubert, which is a super calendared Kraft paper with a water-based silicone release surface.

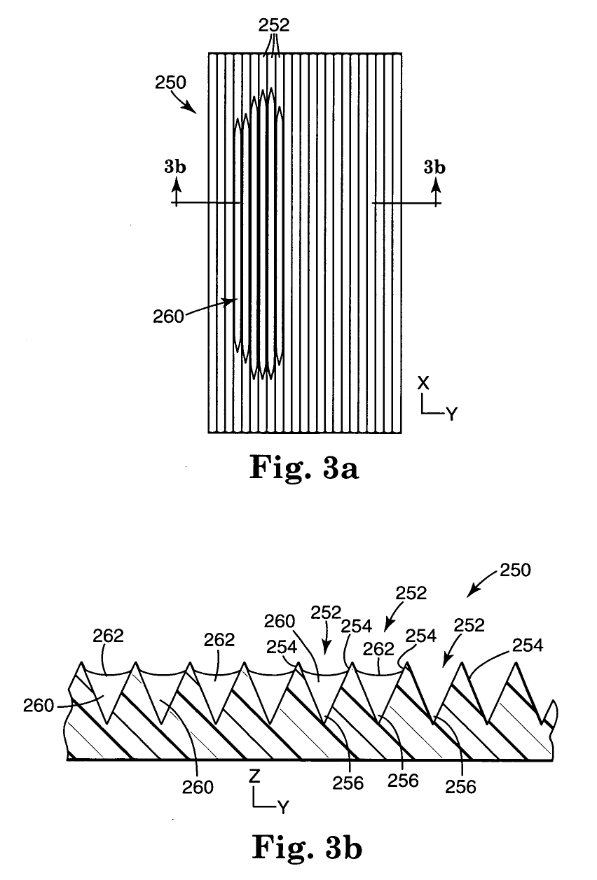

FIGS. 3a and 3b are illustrative of fluid flow effects across the face of a structured surface having a plurality of parallel channels, and specifically, of the increase in exposed fluid surface area achieved when a fluid is disposed on the structured surface of the present invention. A structured surface 250 having a plurality of channels 252 defined thereon has a fluid introduced thereon. In this exemplary illustration, the structured surface has a topography similar to FIG. 2a, with alternating peaks 254 and valleys 256. A fluid 260 introduced onto the structured surface 250. The channels 252 are formed to spontaneously wick the fluid along each channel, which receives fluid therein to increase the spatial distribution of the fluid in the x-direction. As the fluid 260 fills each channel 252, its spatial distribution is also increased in the y-direction between the ridges of each channel 252, and the meniscus height of the fluid 260 varies in the z-direction within each channel 252, as seen in FIG. 3b. Adjacent each ridge, the fluid's exposed surface 262 is higher. These effects in three dimensions serve to increase the exposed evaporatively active surface area of the fluid 260, which, in turn, has the effect of enhancing the evaporation rate of the fluid 260 from the structured surface 250.

The fluid control assembly may comprise an adhesive associated with the fluid control film opposite the microstructured surface to form a tape. The adhesive may be continuous or discontinuous. The adhesive provides a means to mount the tape to a structure in a manner that is consistent with desired fluid flow. The tape can be made with a variety of additives that, for example, make the tape flame retardant, hydrophillic, germicidal, hydrophobic, or capable of wicking acidic, basic or oily materials. The tape can utilize “V”-shaped or “U”-shaped or rectangular shaped micro structures (or combinations thereof) that are aligned in a radial intersecting, linear or any other custom or randomized pattern that is desired for optimal fluid flow in an building and construction design. The tape can also disperse fluid through evaporative mechanisms.

The inventive tape provides an attachment means that allows for negotiation over complex structures with minimal moisture ingress. The attachment means could be any means for attachment such as adhesive, mechanical, electrostatic, magnetic, or weak force attachment means. If the attachment means is an adhesive, the adhesive could be structural or pressure sensitive, and include the broad class of acrylates, non polar acrylates, synthetic rubber, polyolefin, or natural rubber. Mechanical attachment means could include plastiform, locking tapers, or hook and loop backings. Additionally, the tape may be incorporated into the construction, for example nailed. The inventive fluid control film can be used in a wide variety of building assemblies to control moisture and related problems associated with moisture.

In some embodiments, a porous cap layer may be disposed over the fluid control film. Specifically, the cap layer may be disposed over the microstructured surface. The cap layer may be selected from the group consisting of wood, concrete, metal. In one embodiment, the cap layer is porous, and may take the form of a nonwoven material. Generally, the bottom side of the cap layer is affixed to the top side of the fluid control film by a pressure sensitive adhesive or welding.

Suitable fluid control films for use in the present invention are described in U.S. Pat. Nos. 6,290,685; 6,525,488; 6,514,412; 6,431,695; 6,375,871; 5,514,120; 5,728,446; and 6,080,243 and U.S. Publication No. 2002-0011330. Certain fluid control films of the invention are in the form of sheets or films rather than a mass of fibers. The channels of fluid control films of the invention may provide more effective fluid flow than is achieved with webs, foam, or tows formed from fibers. The walls of channels formed in fibers will exhibit relatively random undulations and complex surfaces that interfere with flow of fluid through the channels. In contrast, the channels in the present invention are precisely replicated from a predetermined pattern and form a series of individual open capillary channels that extend along a major surface. These microreplicated channels formed in sheets or films are generally uniform and regular along substantially each channel length, for example from channel to channel. The film or sheet may be thin, flexible, cost effective to produce, can be formed to possess desired material properties for its intended application and can have, if desired, an attachment means (such as adhesive) on one side thereof to permit ready application to a variety of surfaces in use. In some embodiments, it is contemplated that the film may be inflexible.

Certain of the fluid control films of the present invention are capable of spontaneously and uniformly transporting fluids along the film channels. Two general factors that influence the ability of fluid control films to spontaneously transport fluids are (i) the geometry or topography of the surface (capillarity, size and shape of the channels) and (ii) the nature of the film surface (e.g., surface energy). To achieve the desired amount of fluid transport capability the designer may adjust the structure or topography of the fluid control film and/or adjust the surface energy of the fluid control film surface. In order for a closed channel wick made from a fluid control film to function it generally is sufficiently hydrophilic to allow the desired fluid to wet the surface. Generally, to facilitate spontaneous wicking in open channels, the fluid must wet the surface of the fluid control film, and the contact angle be equal or less than 90 degrees minus one-half the notch angle.

The inventive fluid control films can be formed from any polymeric materials suitable for casting or embossing including, for example, polyolefins, polyesters, polyamides, poly(vinyl chloride), polyether esters, polyimides, polyesteramide, polyacrylates, polyvinylacetate, hydrolyzed derivatives of polyvinylacetate, etc. Specific embodiments use polyolefins, particularly polyethylene or polypropylene, blends and/or copolymers thereof, and copolymers of propylene and/or ethylene with minor proportions of other monomers, such as vinyl acetate or acrylates such as methyl and butylacrylate. Polyolefins readily replicate the surface of a casting or embossing roll. They are tough, durable and hold their shape well, thus making such films easy to handle after the casting or embossing process. Hydrophilic polyurethanes have physical properties and inherently high surface energy. Alternatively, fluid control films can be cast from thermosets (curable resin materials) such as polyurethanes, acrylates, epoxies and silicones, and cured by exposure radiation (e.g., thermal, UV or E-beam radiation, etc.) or moisture. These materials may contain various additives including surface energy modifiers (such as surfactants and hydrophilic polymers), plasticizers, antioxidants, pigments, release agents, antistatic agents and the like. Suitable fluid control films also can be manufactured using pressure sensitive adhesive materials. In some cases the channels may be formed using inorganic materials (e.g., glass, ceramics, or metals). Generally, the fluid control film substantially retains its geometry and surface characteristics upon exposure to fluids.

In some embodiments, the fluid control film may include a characteristic altering additive or surface coating. Example of additives include flame retardants, hydrophobics, hydrophylics, antimicrobial agents, inorganics, corrosion inhinitors, metallic particles, glass fibers, fillers, clays and nanoparticles.

The surface of the film may be modified to ensure sufficient capillary forces. For example, the microstructured surface may be modified in order to ensure it is sufficiently hydrophilic. The films generally may be modified (e.g., by surface treatment, application of surface coatings or agents), or incorporation of selected agents, such that the film surface is rendered hydrophilic so as to exhibit a contact angle of 90° or less with aqueous fluids.

Any suitable known method may be utilized to achieve a hydrophilic surface on fluid control films of the present invention. Surface treatments may be employed such as topical application of a surfactant, plasma treatment, vacuum deposition, polymerization of hydrophilic monomers, grafting hydrophilic moieties onto the film surface, corona or flame treatment, etc. Alternatively, a surfactant or other suitable agent may be blended with the resin as an internal characteristic altering additive at the time of film extrusion. Typically, a surfactant is incorporated in the polymeric composition from which the fluid control film is made rather than rely upon topical application of a surfactant coating, since topically applied coatings may tend to fill in (i.e., blunt), the notches of the channels, thereby interfering with the desired fluid flow to which the invention is directed. When a coating is applied, it is generally thin to facilitate a uniform thin layer on the structured surface. An illustrative example of a surfactant that can be incorporated in polyethylene fluid control films is TRITON™ X-100 (available from Union Carbide Corp., Danbury, Conn.), an octylphenoxypolyethoxyethanol nonionic surfactant, e.g., used at between about 0.1 and 0.5 weight percent. An illustrative method for surface modification of the films of the present invention is the topical application of a 1 percent aqueous solution of the reaction product comprising 90 weight percent or more of:

Other surfactant materials that are suitable for increased durability requirements for building and construction applications of the present invention include Polystep® B22 (available from Stepan Company, Northfield, Ill.) and TRITON™ X-35 (available from Union Carbide Corp., Danbury, Conn.).

A surfactant or mixture of surfactants may be applied to the surface of the fluid control film or impregnated into the article in order to adjust the properties of the fluid control film or article. For example, it may be desired to make the surface of the fluid control film more hydrophilic than the film would be without such a component.

Embodiments of the present invention retain the desired fluid transport properties throughout the life of the product into which the fluid control film is incorporated. Generally, the surfactant is available in sufficient quantity in the article throughout the life of the article or is immobilized at the surface of the fluid control film. For example, a hydroxyl functional surfactant can be immobilized to a fluid control film by functionalizing the surfactant with a di- or tri-alkoxy silane functional group. The surfactant could then be applied to the surface of the fluid control film or impregnated into the article with the article subsequently exposed to moisture. The moisture would result in hydrolysis and subsequent condensation to a polysiloxane. Hydroxy functional surfactants, (especially 1,2 diol surfactants), may also be immobilized by association with borate ion. Suitable surfactants include anionic, cationic, and non-ionic surfactants, however, nonionic surfactants may be used due to their relatively low irritation potential. Examples include polyethoxylated and polyglucoside surfactants, such as polyethoxylated alkyl, aralkyl, and alkenyl alcohols, ethylene oxide and propylene oxide copolymers, alkylpolyglucosides, polyglyceryl esters, and the like. Other suitable surfactants are disclosed in Ser. No. 08/576,255.

As discussed above, a surfactant such as a hydrophilic polymer or mixture of polymers may be applied to the surface of the fluid control film or impregnated into the article in order to adjust the properties of the fluid control film or article. Alternatively, a hydrophilic monomer may be added to the article and polymerized in situ to form an interpenetrating polymer network. For example, a hydrophilic acrylate and initiator could be added and polymerized by heat or actinic radiation.

Suitable hydrophilic polymers include: homo and copolymers of ethylene oxide; hydrophilic polymers incorporating vinyl unsaturated monomers such as vinylpyrrolidone, carboxylic acid, sulfonic acid, or phosphonic acid functional acrylates such as acrylic acid, hydroxy functional acrylates such as hydroxyethylacrylate, vinyl acetate and its hydrolyzed derivatives (e.g. polyvinylalcohol), acrylamides, polyethoxylated acrylates, and the like; hydrophilic modified celluloses, as well as polysaccharides such as starch and modified starches, dextran, and the like.

As discussed above, a hydrophilic silane or mixture of silanes may be applied to the surface of the fluid control film or impregnated into the article in order to adjust the properties of the fluid control film or article. Suitable silane include the anionic silanes disclosed in U.S. Pat. No. 5,585,186, as well as non-ionic or cationic hydrophilic silanes. Cationic silanes may be used in certain situations and have the advantage that certain of these silanes are also believed to have antimicrobial properties.

Generally, the susceptibility of a solid surface to be wet out by a fluid is characterized by the contact angle that the fluid makes with the solid surface after being deposited on the horizontally disposed surface and allowed to stabilize thereon. It is sometimes referred to as the “static equilibrium contact angle”, sometimes referred to herein merely as “contact angle”.

The fluid control film is associated with a substrate in an exterior building wall assembly. For the purpose of the present application, associated means on the same side as a defined surface, and also in contact, either directly or by other layers, with the surface. The exterior building wall assembly comprises a substrate. Examples of the substrate include a wall frame and a frame for a defined opening (e.g. a window jamb or a door jamb). Additional examples include wall sheathing, a window, a roof, exterior cladding (siding, stucco, brick, etc.) and an exterior protrusion (e.g. electrical outlets). In some embodiments, the entire house is surrounded with the fluid control film (“house wrap”).

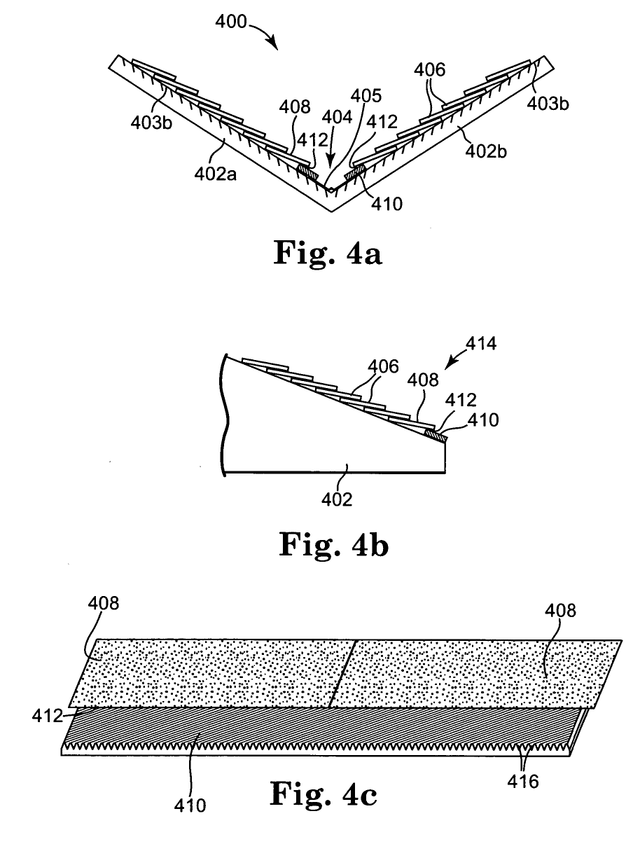

A roof structure 400 is shown in FIG. 4a, where converging roof slopes 402a and 402b meet at valley 404. A galvanized piece of steel or other waterproof material is used as roof valley seal 405 and covers roof valley 404. Roof slopes 402a and 402b have exterior surfaces 403a and 403b, to which are attached roof shingles 406. Roof shingles 406 include a bottom row of shingles 408. Fluid control film 410 is affixed to surface 403 near roof valley 404. Fluid control film 410 is also at least partially underneath the bottom row of shingles 408. The fluid control film 410 forms a seal 412 between the roof surface 403 and shingles 408, allowing water to wick out from under the last row of shingles 408 under the influence of gravity and capillary action, while inhibiting the influx of water upwards and under shingles 408.

A roof edge 414, is shown in FIG. 4b. This is a portion of the roof that is traditionally burdened with potential ice dam formation in cold climates. Here again, fluid control film, 410, acts as a seal 412, as described above, and reduces the potential for ice dam formation.

As shown in FIG. 4c, the channels 416 of fluid control film 410 may be oriented in an elongate diagonal orientation as shown in FIG. 4c, to form a seal 412 as described above in FIGS. 4a and 4b. An alternative orientation of the grooves 416 may be in the machine direction of the fluid control film, parallel with the bottom row of shingles 408, so as to provide a barrier seal against water ingress beneath the bottom row of shingles.

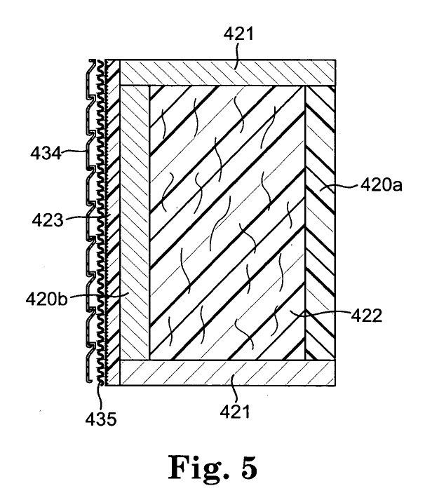

A cross-section of an exterior wall assembly is shown in FIG. 5. Such walls may be built either traditionally with lumber framing (2×4, 2×6 not shown), or modular as exemplified by structural insulated panels (SIPs). FIG. 5 contains a sheetrock section or oriented strand board (OSB), representing the interior facing wall section 420a. An optional insulation layer 422 may be comprised of styrofoam, foaming insulation, fiberglass, and other known forms of insulation material. Exterior facing wall section 420b may be comprised of oriented strand board, plywood, or other material known in construction assemblies. Wall frame component 421 represents any sized piece of wood frame sized to fit as wood cap and base used in modular SIPS panel or a horizontal frame piece of a traditional framed wall structure. Fluid control film 423, is adhesively or structurally attached to the exterior facing wall 420b. The channels of the fluid control film will be oriented vertically so as to slough, shed or direct bulk moisture downward under the force of gravity. The fluid control film can be lapped in a shingle fashion (not shown), with the lowest portion of film attached first and subsequent layers lapping the adjacent layers in a manner so as to shed moisture. Alternatively, the fluid control film can be one large sheet. Exterior cladding or siding 434 of a house or building may be comprised of vinyl siding, cedar shingles, brick, stucco, and other materials known in the construction industry. The fluid control film 423 may be positioned so that the channels of the fluid control film face outward towards the external cladding, siding or stucco 434 or positioned so that the channels face inwards, towards the interior facing wall 420a. Optionally, a non-woven or scrim type of material 435 may be positioned and/or affixed between the fluid control film 423 and the exterior cladding 434, as shown in FIG. 5, or the scrim material 435 may be positioned (not shown) between the fluid control film 423 and the exterior facing wall section 420b. It is also envisioned that a wall assembly will have the fluid control film spanning the wall from the foundation to the roof, with the fluid control film channels primarily in a vertical orientation. An adhesive backed fluid control film may also be used to overlay and seal separate sections of fluid control film covering the wall structure.

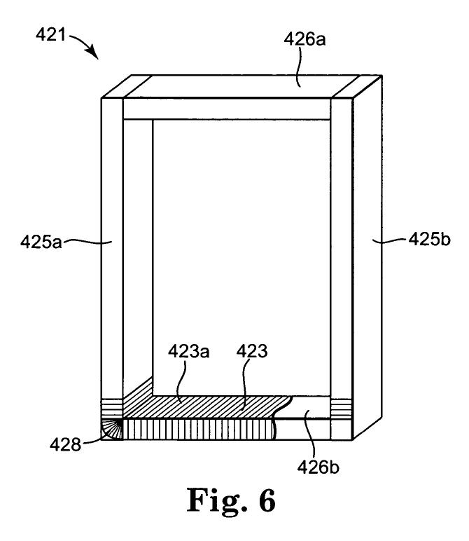

Window frame opening 421, shown in FIG. 6, represents a framed window opening prior to the installation of a window unit. Vertical wall stud or window side jambs 425 and, horizontal wall studs or header jamb 426a and window sill 426b frame the window opening. Window sill 426b may be beveled to facilitate moisture moving away from the opening. Additionally, in one embodiment of the present invention, shown in FIG. 6, fluid control film 423 may applied over the sill 426b with the grooves in an orientation to provide a means for water to be directed away from the window opening. In another embodiment of the present invention the fluid control film 423 may include a hydrophobic portion 423a that can be used to actively encourage moisture to enter the channels. Optionally, a corner piece 428, may be used to remove moisture from the corner of the windows.

The substrate has a major surface. In some embodiments, the major surface has a plane that is parallel to the plane of the exterior wall building assembly. In other embodiments, the major surface has a plane that is not parallel to the plane of the exterior wall building assembly. For example, the exterior wall assembly has a thickness, and the plane of the substrate major surface may be through the thickness. One specific example of such an orientation is on the bottom of a door or window jamb as exemplified in FIG. 6. The channels on the fluid transport film may be parallel and orientated in the direction of fluid flow.

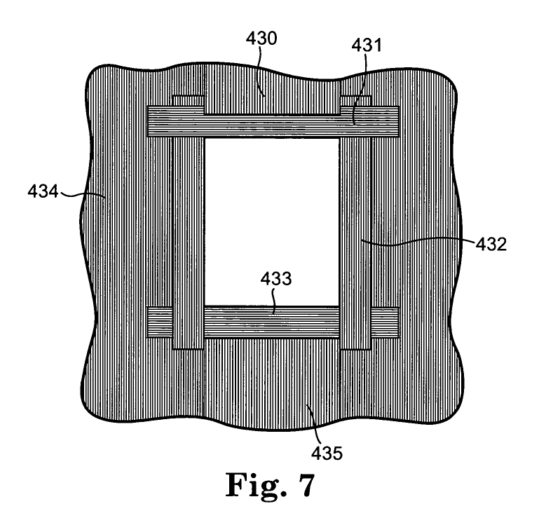

FIG. 7 shows an exterior window opening, around which fluid control film is utilized in various lapped positions. One embodiment of the present invention would provide a top section 430 which overlaps head flashing 431, which overlaps side jambs 432, which overlap sill flashing 433 which overlap housewrap 434 and below window section 435 of fluid control film, to provide a means for water to be shed from the wall and window area through capillary action and gravity. House wrap 434 can represent a discrete piece of film or a continuous housewrap material, providing connectivity in fluid drainage. Window sill flashing 433 can extend to 434 or optionally may be continued on each side and redirected at a 90 degree angle downward, in an upside-down “U” shape (not shown) extending to the bottom of the wall structure for full water drainage.

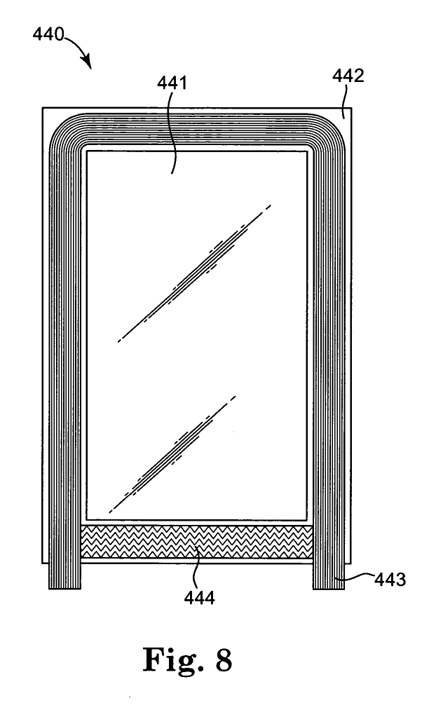

In another embodiment of the resent invention as shown in FIG. 8, a window unit assembly 440, includes a window pane 441 held in place by window unit molding 442. A fluid control film 443 is affixed to the top and sides of the window unit molding 442 and optionally may be conformable around corners of the window to provide continuous fluid management for water shedding through capillary action. A fluid control film with an alternative groove structure 444 designed to allow air flow may optionally be positioned below the window pane 441. Fluid control film 443 can be connected to a house wrap fluid control film 434 as shown in FIG. 7.

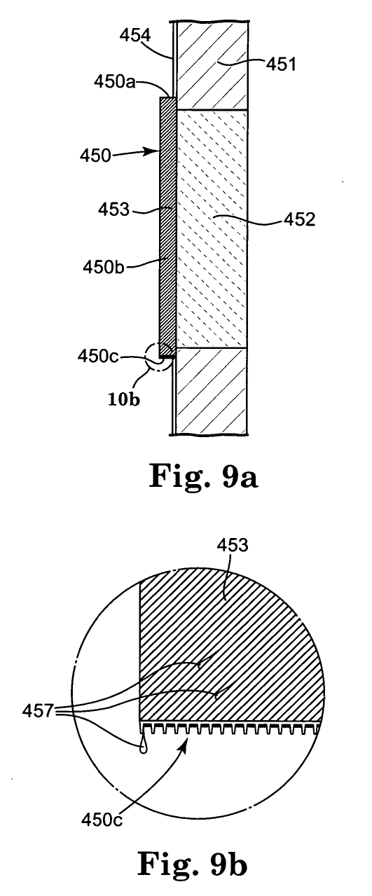

An exterior protrusion 450 of a wall assembly 451 is shown in FIG. 9a. The exterior wall protrusion 450 may be a window treatment for a casement type window or any other structure protruding from the face of the exterior cladding 454 and which may interrupt the water-shedding action of the exterior cladding 454. The exterior wall protrusion 450 may extend from a window or other wall opening 452. In one embodiment of the present invention, the top 450a, sides 450b and optionally the bottom 450c edges of the exterior wall protrusion 450 are covered with a fluid control film 453. Alternatively, the material forming the wall protrusion 450 itself may be formed to incorporate a microstructured fluid control surface. The fluid control film 453 (or fluid control surface) on the side 450b edges of the wall protrusion is positioned to provide channels, which run in a diagonal that is downward and away from the exterior cladding 454, for the purpose of directing, via gravity and capillary action, water 457 and moisture away from the exterior cladding 454, as shown in enlargement FIG. 9b. The fluid control film 453 or fluid control surface of top 450a and bottom 450c, edges of the exterior protrusion 450 have channels, which provide continuous fluid management to and from the side 450c edge of the exterior protrusion 450.

Various modifications and alterations of this invention will become apparent to those skilled in the art without departing from the scope and spirit of this invention. All patents, patent applications and publications cited herein are incorporated by reference. The following example further discloses an embodiment of the invention.

### EXAMPLE

A 6.35 mm wide strip of fluid control film was adhesively applied to a window and door test fixture, and the efficiency of water removal was measured for three different film designs. The test fixture comprises a clear plastic sheet that was used to provide a simulated window or door flashing, and a vertical plastic stand that was used to simulate an exterior wall, as represented by FIG. 8. A rectangular hole was cut in the vertical, clear plastic sheet, to simulate a window or door opening.

The film was applied by first laminating a 50.8 micrometers of a synthetic rubber based adhesive from 3M Company onto a microstructured backing as described below to form a tape. The fluid control film tape was then slit down to 6.35 mm wide by using a razor cutter, with two straight razor blades spaced 6.35 mm apart. The film was cut such that the long axis of the tape was parallel with the channels. The fluid control film tape was then applied as a single piece of tape to the plastic sheet. The tape was hand applied in a straight manor along the side of the plastic sheet, and then the fluid control film tape was applied as a radius around the upper corners as shown in FIG. 8, with no interruptions or cutting of the tape. The tape was then completely applied following these first steps, until the fluid control film tape looked like FIG. 8.

Once the fluid control film tape was applied; the plastic sheet was fastened to the vertical stand, by six machine screws. The machine screws were hand tightened, to attain a secure and firm attachment of the plastic sheet to the vertical stand.

The water transfer efficiency was measured by applying 5 gm of water to the top of the plastic sheet, and comparing that amount to the amount of water that was transferred via wicking along the fluid control film tape. The water was applied so that it flowed in-between the vertical stand surface and the interior surface of the plastic sheet, simulating a water leak around a window or door flashing. Once the water was applied to the test fixture, the water was allowed to wick out for 15 minutes. After 15 minutes, the water was collected at both ends of the fluid control film tape into the vials, and then weighed. This was repeated twice for each tape. The efficiency was then calculated as the ratio of the weight of the water collected, divided by the weight of the water applied. This efficiency is then a measure of the fluid control film tape's ability to seal the window or door flashing, and its ability to remove fluid that gets between the window or door and the wall.

While it was not measured, it is understood that the water transfer efficiency would be 0 in the absence of any fluid control film. Any water that gets behind the window or door would infiltrate in an uncontrolled manner and be very difficult to control. This problem is a known problem in window and door related water damage.

Tape A is the tape described in example 15 of U.S. Pat. No. 6,531,206, where the fluid control film tape has an 8 mil deep rectangular channels with smaller nested channels between the larger channels.

Tape B is the tape described in example 14 of U.S. Pat. No. 6,531,206, where the fluid control film tape has a 10 mil deep 80 degree V groove.

Tape C is the tape described in example 13 of U.S. Pat. No. 6,531,206, where the fluid control film tape has a 20 mil deep 45 degree V groove.

| Sample | Tape A | Tape B | Tape C |
|---|---|---|---|
| Trial 1 | 2.54 gm | 3.66 gm | 4.63 gm |
| Trial 2 | 3.48 gm | 3.64 gm | 4.66 gm |
| Average Efficiency (%) | 60.2% | 70.3% | 92.9% |

While a specific combination of components may be disclosed as an embodiment, it is contemplated that the disclosed features of various embodiments may be combined to achieve the objectives of the claimed invention. Various modifications and alterations of the present invention will become apparent to those skilled in the art without departing from the spirit and scope of the invention.

1. A fluid control assembly comprising:
a fluid control film comprising a first side and a second side, the first side comprising a microstructured surface with a plurality of channels on the first side; and
an exterior building wall assembly comprising a substrate layer having a major surface, the substrate major surface associated with the fluid control film.

2. The fluid control assembly of claim 1 wherein the substrate major surface is associated with the first side of the fluid control film.

3. The fluid control assembly of claim 1 wherein the substrate major surface is associated with the second side of the fluid control film.

4. The fluid control assembly of claim 1, where the fluid control film is moisture vapor permeable.

5. The fluid control assembly of claim 1, further comprising a non-woven layer associated with the first side of the fluid control film.

6. The fluid control assembly of claim 1, where the substrate is a sealed insulated panel.

7. The fluid control assembly of claim 1, further comprising adhesive on the on the second side of the fluid control film.

8. The fluid control assembly of claim 7, wherein the adhesive is a continuous layer.

9. The fluid control assembly of claim 7, wherein the adhesive is discontinuous.

10. The fluid control assembly of claim 1 wherein the substrate is a frame for a defined opening.

11. The fluid control assembly of claim 10 wherein the frame is a window jamb.

12. The fluid control assembly of claim 10 wherein the frame is a doorjamb.

13. The fluid control assembly of claim 1 wherein the substrate is a window sill.

14. The fluid control assembly of claim 1 wherein the substrate is wall sheathing.

15. The fluid control assembly of claim 1 wherein the substrate is a window.

16. The fluid control assembly of claim 1 wherein the substrate is a roof.

17. The fluid control assembly of claim 1 wherein the substrate is exterior cladding.

18. The fluid control assembly of claim 1 wherein the substrate is an exterior protrusion.

19. The fluid control assembly of claim 1 wherein the substrate has an interior side and an exterior side.

20. The fluid control assembly of claim 1 wherein the fluid control film comprises an anti-microbial additive.

21. The fluid control assembly of claim 1 wherein major surface of the substrate is in a plane parallel to the plane of the wall assembly.

22. The fluid control assembly of claim 1 wherein the major surface of the substrate is in a plane not parallel to the plane of the wall assembly.

23. A method of controlling fluid in a wall assembly comprising
providing an exterior building wall assembly;
providing a fluid control film, the fluid control film comprising a first side and a second side, the first side comprising a microstructured surface with a plurality of channels on the first side; and
affixing the fluid control film to a surface of the wall assembly.
